(19) United States
(12) Patent Application Publication
(10) Pub. No.: US 2022/0405485 A1
(43) Pub. Date: Dec. 22, 2022

(54) NATURAL LANGUAGE ANALYSIS OF USER SENTIMENT BASED ON DATA OBTAINED DURING USER WORKFLOW

(71) Applicant: Airbnb, Inc., San Francisco, CA (US)

(72) Inventors: Kevin Jungmeisteris, Bellevue, WA (US); Carter Appleton, Seattle, WA (US); Vibha Bamba, San Francisco, CA (US); Guqian Du, Foster City, CA (US); Hwanghag Jeong, San Francisco, CA (US); Artem Kizil, Seattle, WA (US); Jonathan Li On Wing, Issaquah, WA (US); Patrick Srail, Los Angeles, CA (US); Yufeng Zhang, Redmond, WA (US); Cen Zhao, Foster City, CA (US)

(73) Assignee: Airbnb, Inc., San Francisco, CA (US)

(21) Appl. No.: 17/870,626

(22) Filed: Jul. 21, 2022

Related U.S. Application Data
(60) Provisional application No. 63/191,855, filed on May 21, 2021.

(51) Int. Cl. G06F 40/35; G06F 3/0484; G06F 40/166; G06F 40/126; G06Q 30/00

(52) U.S. Cl. CPC G06F 40/35; G06F 3/0484; G06F 40/166; G06F 40/126; G06Q 30/016

(57) ABSTRACT

A text-based real-time communication interface, such as a chatbot, is presented to a user for the exchange of customer support information. A user's freeform text input is analyzed using machine learning algorithms to derive the meaning of the input text as well as to determine the user sentiment expressed therein. These determinations may be further supported by signals extracted from session-based activity, which signals can be used to infer the intended workflow of the user and whether or not that workflow was achieved. The expressed user sentiment is considered along with other historical or session-based user data to generate tailored questions and responses to be delivered in real-time to the user. The responses are displayed to the user along with information that routes the user to a workflow resolution.

### RELATED APPLICATIONS

This application claims the benefit of U.S. Provisional Patent Application No. 63/191,855 filed on May 21, 2021, entitled “Natural Language Analysis of User Sentiment Based on Data Obtained During User Workflow”, U.S. Provisional Patent Application No. 63/191,859 filed on May 21, 2021, entitled “Natural Language Analysis of User Sentiment Based on Data Obtained During User Workflow”, and U.S. Provisional Patent Application No. 63/191,913 filed on May 21, 2021, entitled “Natural Language Analysis of User Sentiment Based on Data Obtained During User Workflow”, each of which is incorporated by reference herein in its entirety.

### BACKGROUND

Web or application-implemented systems that allow for direct customer engagement often use customer support systems that seek feedback through survey data. These web or cloud-based systems may help users perform a limitless variety of tasks, a common one being e-commerce websites that permit users to buy, rent, or reserve products and/or services. Typically, the user of such a site performs such tasks (e.g., purchasing) themselves, using the website as a tool for facilitating the transaction. If during the transaction, the user contacts customer support for assistance, the system may gauge that user's satisfaction with their experience through later-delivered email or text surveys. The system may then perform analytics on aggregated survey response data, for example on a ticket topic or a problem severity. Dashboards or reports may also be generated based on the aggregated data.

Other systems may offer intercept surveys that ask questions to a user in the form of surveys presented during the user's engagement with the website or application. These surveys often pop up a standard or default question (such as “do you require any assistance?”) in a chat application or bot, for example after the user has been on a website for a predetermined amount of time. The user's answers (whether free-typed or selected from a choice of options) are used to direct the conversation down predetermined decision trees, with preset responses in the selected branch being delivered in order to a user. Similarly, persistent surveys, such as a “provide feedback” button or option that is constantly present on a screen, may be used. The development of these question and answer surveys provide the customer with some degree of self-help, so long as their issues can be identified and resolved within the predetermined set of responses.

However, all of these conventional scenarios all suffer from problems. Initially, customer participation in a voluntary survey or chat is typically very low. This is particularly true when there is a channel shift between the customer experience and the survey (e.g., website to email). Thus, any feedback received may not necessarily be accurate for extrapolation to the larger customer population. Among the customers that do respond, the participants are overwhelmingly those that are upset or unhappy with customer service, leading to skewed results.

Further, because these surveys are often generic and depend on the customer's initiation (i.e., the customer clicking on the option for the survey) and self-evaluation of their experience, they may not help the customer to solve their problem in the moment. Intercept or persistent surveys that are unsatisfactory, repetitious, or confusing may lead to customers being dissatisfied or angry. For email surveys in particular, there is a delay between the time of interaction and the time the user submits the survey, making the survey even further removed from the actual experience. Accordingly, these customer support surveys do not enhance user experience or customer support outcomes.

Even where a customer submits a conventional survey, the information therein may not be valuable or actually indicative of the user's level of satisfaction. Metrics captured in survey data are conventionally directed to measurable data such as a number of tickets (complaints), a number of visits, a number of purchases, and so on. Typically, these metrics, such as Net Promoter Score (NPS) are tied to business growth or commercial success. However, while metrics are being collected in these conventional solutions, and while the collected metrics may allow for inferences into whether the technical offerings of the computer system are commercially successful, such metrics do not actually indicate whether the customer was happy or satisfied with the process. That is, industry-standard customer service metrics like NPS may not provide an accurate view into customer happiness.

Technical solutions for more dynamic, accurate, and timely customer sentiment analysis are therefore generally desired.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 is a diagram of an environment including a sentiment analysis system with some embodiments of the present disclosure.

FIG. 2A is a block diagram of select component parts of a customer support system in accordance with some embodiments of the present disclosure.

FIG. 2B is a diagram of an exemplary data storage structure for data relating to a sentiment analysis and/or workflow analysis in accordance with some embodiments of the present disclosure.

FIG. 3 is an exemplary graphical user interface in accordance with some embodiments of the present disclosure.

FIGS. 4A, 4B, 4C, and 4D are exemplary graphical user interfaces in accordance with some embodiments of the present disclosure.

FIG. 4E is a diagram of an exemplary communication flow between components of a customer support system in accordance with some embodiments of the present disclosure.

FIG. 5 is an exemplary flowchart of a text-based sentiment analysis process in accordance with some embodiments of the present disclosure.

FIG. 6 is an exemplary flowchart of a workflow evaluation process in accordance with some embodiments of the present disclosure.

In the figures, the leftmost digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

The methods and systems described herein may be used to collect customer feedback and leverage sentiment analysis as a proxy to determine customer satisfaction with a service, a customer support interaction or other customer interaction. For example, a customer's messaging or dialog with another user (e.g., a host or customer service agent) or interactions with a service can be monitored and analyzed to determine the customer's current sentiment. If the customer's sentiment is determined to be falling or getting worse, the system can intervene to attempt to resolve the situation for the customer. A numeric sentiment score is derived and updated in real-time based on implicit signals of customer satisfaction obtained from a user's freeform text entry (obtained, for example, from a survey, a chatbot, an interaction with a customer service agent or an interaction with another user) and/or the user's selection interaction with an intercept survey or a post-activity survey in the same channel as the user's activity, as well as other relevant information. The questions asked in the survey may be guided by the user's activity with the service, e.g., on an e-commerce website, the workflow followed by the user and a determination of when and how the user engaged customer support in the workflow process. In some embodiments, the questions and/or responses presented to the user via the survey or chatbot are associated with a “tone” of response, the tone of response being dictated by the derived sentiment score.

In an exemplary embodiment, the intercept survey is a freeform text survey present during the user's interaction with a computer system (e.g., on a website or application), presented before the initialization of a help ticket and without the need for default or generic questions in a post-event survey. Typically, these surveys are presented as a series of text questions and/or informational statements, to which the user can type their response.

Rather than presenting questions to the user in accordance with predetermined decision trees, in the exemplary embodiment, the computer system may dynamically generate or select text, in real-time, to present to the user in the intercept survey or a chatbot based on information about the user and the workflow of the user in the particular session. For example, information about the path or workflow the user took during their support journey (their activity) can be used to dynamically select a set of one or more questions to use in the user interaction. The user can then respond with one or more character strings, typically input as freeform text, which user responses can be used to dynamically evaluate or reevaluate the next question to be asked of the user, and/or information to be presented to the user.

In an embodiment, a user accessing a website may initiate communication with a customer support application or widget, by either clicking on a support feature or responding to a presented customer support inquiry. In particular, the user may input a character string (e.g., as freeform text) with the intent of receiving a responsive message or instruction. The input character string is transmitted (in some embodiments, the string being tokenized, and in others, not being tokenized) from a user device to a web server, and then to a sentiment analysis system. In some embodiments, the sentiment analysis system is capable of performing semantic parsing to capture the meaning of the input text. The sentiment analysis system includes a pre-trained natural language processing (NLP) model capable of generating vector representations of the input text. In an exemplary embodiment, the model is capable of generating a series of vectors (each corresponding to a word) so as to be representative of a sentence, or another measurement of text.

In an exemplary embodiment, sentiment analysis is done based on the user's natural language text entered into the intercept survey or chatbot to understand the meaning of the statement, request, or question input by the user. In addition, the user's relative happiness or satisfaction at the time they input the text may be gauged by a sentiment analysis. For each user response, a sentiment score is dynamically determined, as well as any change of user sentiment a Δ (delta) sentiment score from the previously calculated score. By these means, a sequence of sentiment scores is obtained over the course of a chat conversation at a fine level of granularity, and can be used at different levels of aggregation to take one or more actions or generate reports.

In an exemplary embodiment, the sentiment score is used by the e-commerce system to recommend or select an action to take in response to the user, tailored to fit the calculated sentiment. Such actions may include, for example, a selection or modification of a tone of language used in a response (e.g., to be more formal/casual, apologetic, deferential, straightforward, and so on), a routing point (to a website, hyperlink, or button/interface), an escalation to a human mediator/agent or higher support level, and/or the direction of the user to a different workflow (e.g., a self-solve workflow).

In an exemplary embodiment, in addition to the sentiment analysis, the selection of a responsive action may include a rules-based contextual analysis, based on, e.g., the time of day, the location, or other circumstances of the user.

In some embodiments, the system may identify circumstances that “trigger” the presentation of a user interface to gather additional information from a user or provide information to a user. The user interface provided to the user can be to: 1) ask questions to identify the user's intent; 2) ask questions (or provide a survey) to gauge the user's happiness and/or satisfaction; 3) provide information to the user based on an understanding of the user's intent; and/or 4) provide an action or workflow to the user so the user can solve a problem. For instance, an unusual, circuitous, or misdirected progression of user activity during a task could indicate that the user's workflow to accomplish a particular goal (e.g., making a reservation) has been derailed. This determination may function as a trigger to display a user interface, either an intercept survey (or other survey) or a chatbot (or instant answer), to the user for additional support. As another example, sentiment analysis of a user's entered character string (e.g., freeform text) in a search bar, messenger app, or other input interface may indicate user frustration or confusion, and may be used as a trigger for additional support through an intercept survey or chatbot. Communication from the intercept survey or chatbot may then be used to conduct further sentiment analysis.

The workflow analysis may be maintained until the user finishes their session, and an analysis may be performed to determine whether the user was able to complete their workflow. As one example, if the user wishes to make a purchase and has taken steps in their session workflow in that direction, the system may determine whether the purchase was ultimately completed within the session after the customer support interaction (e.g., through the intercept survey). If the workflow was completed, the system may infer that the customer support interaction was generally successful. The number, timing, and/or flow of screens visited by the customer after their customer support interaction in the completion of the workflow can be used to determine whether a heavy manual lift (that is, self-service action by the customer) was needed after the customer support interaction.

In one embodiment, the computer system may be an online reservation system that displays to potential customers properties, such as houses, condominiums, rooms, apartments, lots, and other real estate, offered to the potential customer (or guest) by an owner/manager of the property for reservation (sometimes referred to as a “booking” or “rental”) for a specified time period (e.g., a day, week, month, or another period of interest). The owner of a property may contract with the merchant managing the online reservation system to use the system to display a property “listing” for the reservable property. When a customer books a property, the merchant's online reservation system may allow for intake, from the customer, of a booking fee, an initial setup fee, a recurring fee, no fee, and/or any other appropriate value. In some instances, the merchant may also handle and/or facilitate one or more financial transactions relating to the purchase or booking of that property, and may receive a fee in relation thereto. The systems and methods described herein are of course not limited to systems relating to property listings; rather, they may be provided for any website, application, or e-commerce system that may potentially provide text-based customer support features.

In conventional solutions for customer support, the ability to measure customer feedback was highly dependent on manual evaluation. For example, raw information may be collected from survey results, but this data must be manually reviewed and categorized, except for the very broadest levels of classification (such as ticket type or product name, etc.). Such a process is prone to human error and interpretative bias.

Survey data is conventionally presented to a user in the form of email surveys (after a customer support interaction), intercept surveys (typically triggered by elapsed time or page hit), or persistent surveys (e.g., a “provide feedback” flyout or button that is persistent on the page in view of the user). Each of these solutions require a user to initiate (e.g., click) and fill out information. Typically, the outcomes of these surveys will suffer from survey bias, where participants are overly pessimistic, and low engagement rate across the user population. Additionally, for email surveys, there is often a delay between the time of interaction and the time the user sends the survey. Further, a survey forces a channel shift for a user on a website or application or speaking to a customer support person by phone.

Further still in conventional solutions, customer feedback (e.g., on satisfaction) is collected separately from the actual self-serve workflow of the customer. That is, the question of whether the customer was actually able to achieve their goal is separate from the question of whether they were dissatisfied with the process or outcome. Depending on the user response, one or both of these questions may remain unanswered. As a result, the data collected may be insufficient, or unaligned. Metrics generated from such data sets may lack accuracy or thoroughness.

In contrast to conventional solutions, the systems and methods described herein allow for higher user response rate, reduction of bias, and reduction of delay in the collection and analysis of survey results. Further, the customer support system and methods described herein may target users over various channels, such as a website or application's help center (or help/feedback widget), chat function or bot (also referred to herein as a chatbot), and/or messaging features. Accordingly, the user is more likely to have access to a survey element within the channel they are currently occupying and acting within (e.g., website). In the systems and methods described herein, even if a user chooses not to participate in a survey, accurate and useful metrics regarding their satisfaction can still be collected based on their activity and workflow on and through the computing system.

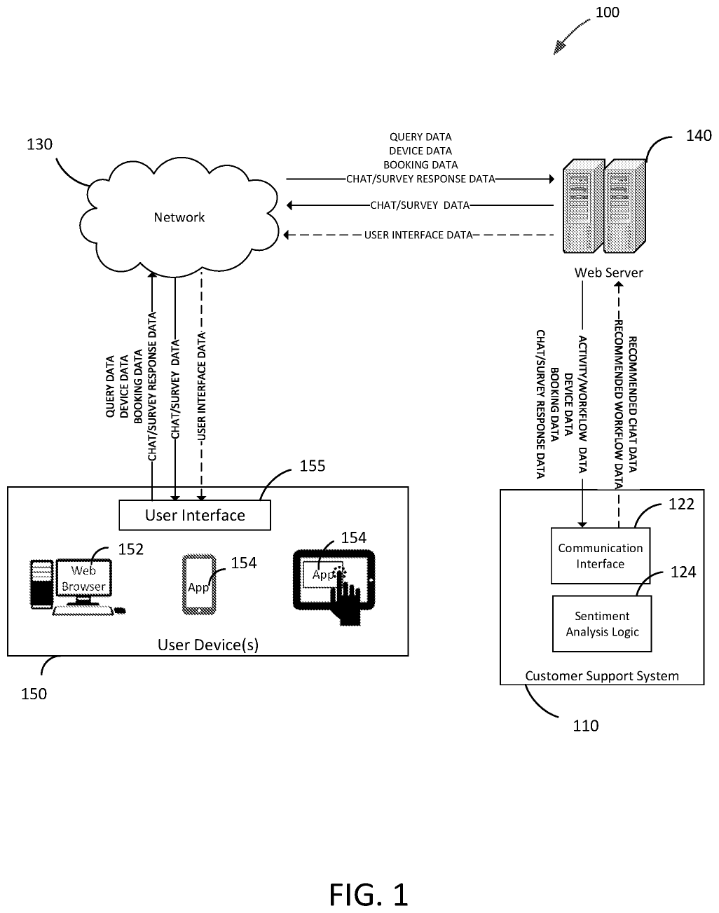

FIG. 1 depicts a block diagram of an environment 100 including a customer support system 110 in accordance with some embodiments of the present disclosure. The components of environment 100 relate to systems, methods, and interfaces for collecting customer feedback and altering customer service response based on the sentiment expressed in the feedback as well as the actual semantic meaning thereof. In the embodiment of FIG. 1, customer support system 110 is managed or facilitated (and in some embodiments owned) by a service provider. The service provider may be generally understood as an individual, entity, or organization that displays or delivers to an end user (a customer) information and/or user interfaces to allow the user to select, view, and/or access electronic content. The systems and methods described herein may be provided for any type of service provider offering a customer-facing interface that can take in customer feedback in at least text form (or in a manner that can be converted to text, such as voice-to-text).

In some embodiments, the customer support system 110 may provide an online reservation system that displays listings of properties, such as houses, condominiums, rooms, apartments, lots, and other real estate that are owned by different respective hosts, and that have been offered for reservation and that may be reserved for a specified time period (e.g., a day, week, month, or other window of interest) by a guest. In such embodiments, a product can be understood as a reservation for a particular physical property during a particular range of time (e.g., a day or set of days). Other embodiments are not limited to property rental, or to any other particular purpose or industry.

FIG. 1 illustrates that environment 100 may include one or more of devices connected to a network 130. Network 130 may include one or more network types, such as a wide area network (such as the Internet), a local area network (such as an intranet), a cellular network or another type of wireless network, such as Wi-Fi, Bluetooth, Bluetooth Low Energy, and/or other close-range wireless communications, a wired network, such as fiber optics and Ethernet, or any other such network, or any combination thereof. In some embodiments, the network 130 may be the Internet and information may be communicated between system components in an encrypted format such by a transport layer security (TLS) or secure socket layer (SSL) protocol. In addition, when the network 130 is the Internet, the components of the environment 100 may use the transmission control protocol/Internet protocol (TCP/IP) for communication.

As shown in FIG. 1, a sentiment analysis logic 124 may be implemented by a customer support system 110 or other type of device or system that is connected to a network 130 via at least one communication interface 122. Additionally connected to network 130 is at least one web server 140 (which in some embodiments may be part of a system that also houses or is integral with the customer support system 110). In some embodiments, the customer support system 110 and the web server 140 are owned and/or operated by the same entity. In an exemplary embodiment, the web server 140 is connected to the same internal network as the customer support system 110, such that information on the web server 140 may be understood as information “internal” to customer support system 110. In other embodiments, the web server 140 may be any computer system from which customer support system 110 may pull information, including, e.g., document data entered by an end user. In some embodiments, customer support system 110 may collect such information from web server 140 via network 130.

As shown in FIG. 1, web server 140 is communicably accessible to users via their devices 150. For instance, web server 140 may receive query data and/or chat/survey data from and transmit data to one or more user devices, referred to herein individually or collectively as user device(s) 150. A user device 150 may be used by individuals or entities to access, view, and/or take action in response to content delivered to the user from the web server 140. A user device 150 may include, among other things, one or more computing devices, such as a smartphone or other hand-held device (e.g., a tablet or reader), desktop computer, laptop computer, touchscreen device, or any other appropriate device capable of receiving, processing, and outputting digital information via network 130. In an exemplary embodiment, the device 150 presents information to a user via a display on, in, or connected to the device 150, and takes input from the user in relation thereto (for example, through interactive graphics or hyperlinks) via a touchscreen, mouse, keyboard, stylus, or any other appropriate input device.

In the illustrated embodiment, each user device 150 may have installed a web browser 152 and/or other appropriate applications (apps) 154 that can be used to communicate (receive and transmit data) with the system 110 and/or web browser 140 via the network 130. In some embodiments, an app 154 may be a mobile application or other software application distinct from a generic web browser, such as an e-mail, messaging, or social media application, an application specific to the e-commerce business, or another program capable of receiving digital content from the e-commerce processing server 110 and delivering such content to the user device 150. In some embodiments, the user device 150 may present to the user a user interface 155 (e.g., a graphical user interface) through app 154 or web browser 152 allowing for the entering and transmitting of information that may be helpful in the creation of a property listing available for booking. Such information may include any of text, pictures, account information, location information, payment information, and other selections or entered information.

Web server 140 may present different types of data on the user interface 155. For instance, user interface 155 may provide an interface (in some implementations, generated and/or delivered by the web server 140), through which a user can view and/or otherwise access the content of one or more documents, and through interaction with the user interface, can input, create, edit, revise, and/or delete content, such actions affecting changes displayed to the user in real time via the interface. While FIG. 1 illustrates a one-to-one correspondence between a user device and one of a web browser 152 or app 154, the embodiments are not so limited. The digital content transmitted to the user devices 150 from web server 140 may include, e.g., textual content data, formatted web pages/user interfaces, hyperlinks, images, notifications, suggestions, and/or modifiable document representations.

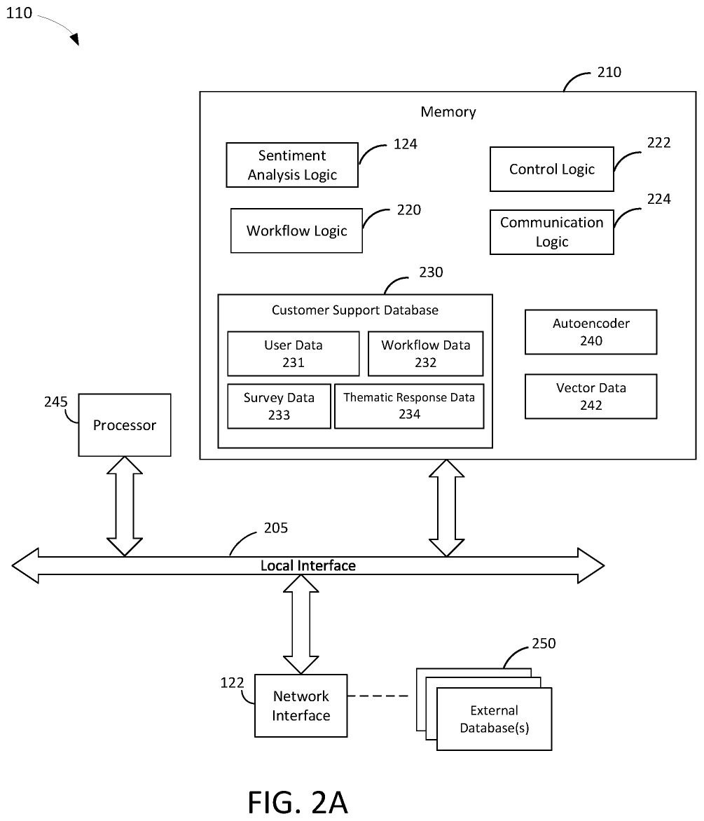

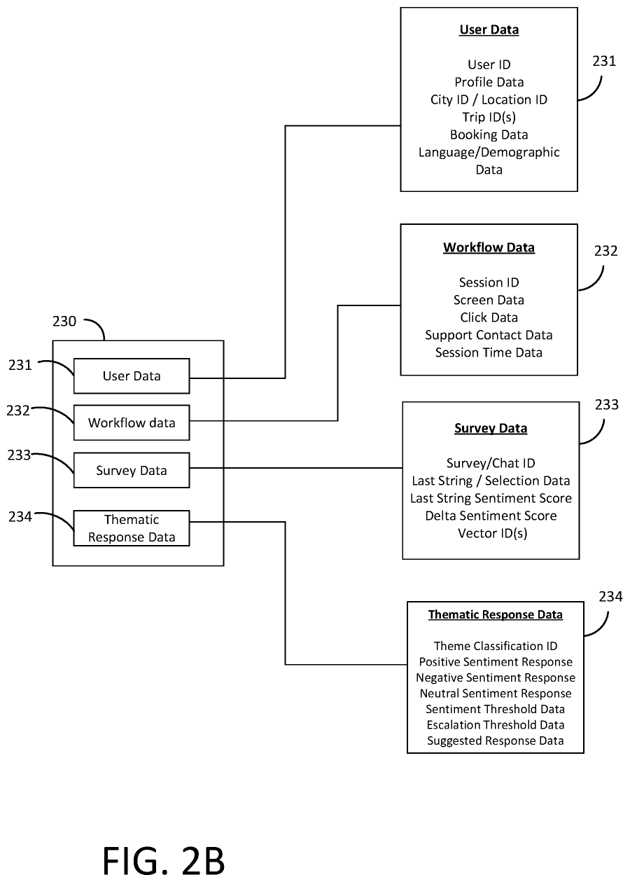

In some embodiments, web server 140 transmits to the user device 150 a user interface that can take in a freeform textual input by the user. In other embodiments, the user may enter a structured input for search, or may input any combination of freeform, structured, or structured input. Customer support system 110 may function to, in response to receiving this information, analyze the content and sentiment of the input and retrieve or pull, from a corpus of response data stored in one or more databases within or communicably accessible to the system 110 (e.g., customer support database 230 as shown in FIG. 2A) a set of one or more records with that contain sentences (character strings) and other data that are most responsive to the user's input. This data might include hyperlinks, document links, instructions, images, videos, selection options (e.g., boxes or radio buttons) that are selectable by a user, or other information that can direct the user's activity and/or attention. The textual content sent to the user may be a textual response to a query or statement (in some embodiments authorized and/or authored by the system 110), and/or a hyperlink to another web-based location that the user can click to address an expressed customer support problem, or the like. The suggested related records may not always be dynamically generated, but may be dynamically selected from a database in response to the words or selections of the user's freeform or structured input so as to be contextually or topically associated with the content of that input. That is, the contextual and semantic meaning of the user's text can be taken into account in providing a real-time response to a support inquiry from a user (e.g., in a web-based interface or chat window). The response is content-related and sentiment related to the user input without limiting the user to predefined selections that would guide them down a preset tree of responses.

FIG. 2 depicts an example schematic diagram of certain components of customer support system 110 in accordance with some embodiments of the present disclosure. The customer support system 110 may include a memory 210. As used herein, memory 210 may refer to any suitable storage medium, either volatile and non-volatile (e.g., RAM, ROM, EPROM, EEPROM, SRAM, flash memory, disks or optical storage, magnetic storage, or any other tangible or non-transitory medium) that stores information that is accessible by a processor. Memory 210 may store instructions and data used in the systems and methods described herein. Customer support system 110 may also include a RAM or other volatile or other memory accessible by a CPU/processor 245. In addition, system 110 may access, for example via local interface 205, a hard disk drive (HDD) or other permanent storage (not specifically shown). While FIG. 2A illustrates discrete components corresponding to memory 210 and customer support database 230, it will be understood that the embodiments described herein are not limited to any particular arrangement and that other embodiments may store information in one combined memory, in one or more memories, some local to the other components illustrated in FIG. 2A and/or some shared with, or geographically located near, other remote computing systems.

As illustrated in FIG. 2A, memory 210 contains sentiment analysis logic 124 and workflow logic 220, as well as an autoencoder 240. Memory 210 may also contain control logic 222, including one or more algorithms or models for generally controlling the operation of the customer support system 110 and communication logic 224 for communicating between various components illustrated in FIGS. 1 and 2A. These depicted logics may variously represent one or more algorithms, computational models, decision making rules or instructions, or the like implemented as software code or computer-executable instructions (i.e., routines, programs, objects, components, data structures, etc.) that, when executed by one or more processor(s) 245, program the processor(s) to perform the particular functions of their respective logic. These logics are depicted in FIG. 2A as several discrete components, each labeled individually, however, in various embodiments, the functions of each respective logic may be executable on their own or as part of one or more other modules; that is, any configuration of the depicted logical components may be used, whether implemented by hardware, software, firmware, or any combination thereof. The capabilities of these various logics are described in greater detail below.

The system 110 may include control logic 222, including one or more algorithms or models for generally controlling the operation of the system 110. The memory 210 may also, in one embodiment, include communication logic 224, including one or more algorithms or models for obtaining information from or communicating information with web server 140, database 250 (or other external or third party databases), and/or via network 130 (FIG. 1). The system 110 may, via communication interface 122, operate to exchange data with various components and/or devices on the network 130 or any other network. For instance, communication interface 122 and communication logic 224 may be used (by, e.g., sentiment analysis logic 124 and/or workflow logic 220 in the manner(s) described in greater detail below), to access data from web server 140. In some embodiments, communication logic 224 may use application programming interfaces (APIs) provided by web server 140 to obtain stored data, however, other methods of data collection may alternatively be used such as one or more software development kits, which may include, e.g., APIs, web APIs, tools to communicate with embedded systems, or any other appropriate implementation.

While communication logic 224 is illustrated as being a separate logical component, in an alternative embodiment, the system 110 may include communication logic 224 as part of sentiment analysis logic 235, workflow logic 220, or control logic 222. In another alternative embodiment, the communication logic 224 may communicate with third-party systems and/or may coordinate with the control logic 222 to read or write data to memory 210, or to another data repository (not shown) within or accessible to the system 110.

In some embodiments, system 110 may be implemented in whole or in part as a machine learning or deep learning system (e.g., neural network software, such as a Convolutional Neural Network (CNN)) or other rules-based system for achieving the functionalities described herein. In one embodiment, one or more of sentiment analysis logic 124, workflow logic 220, or autoencoder 240 or any subset of any of those logics) may be implemented at least in part as one or more machine learning algorithms. For instance, autoencoder 240 may be understood as a type of artificial neural network used to produce encodings (e.g., vectors) representative of features in a set of data in an unsupervised manner. In general, autoencoder 240 may include one or more machine learning models for dimensionality reduction of text and one or more machine learning models for reconstructing (generating a representation close to the original text from the reduced encoding).

While, in the exemplary embodiment, each of sentiment analysis logic 124, workflow logic 220, autoencoder 240, control logic 222, and communication logic 224 is depicted as part of customer support system 110, these logical components need not be so configured, and in other embodiments, other configurations of the various components, within system 110 or distributed over one or more computing systems, are possible. Sentiment analysis logic 124, workflow logic 220, autoencoder 240, control logic 222, and communication logic 224 may be variously implemented in software, hardware, firmware or any combination thereof. In the exemplary system 110 shown in FIG. 2A, these logics are implemented in software and are stored in memory 210. Note that these components, when implemented in software, can be stored and transported on any non-transitory computer-readable medium for use by or in connection with an apparatus (e.g., a microprocessor) that can execute instructions. In the context of this disclosure, a “computer-readable medium” can be any device or system that can contain or store a computer program for use by or in connection with an instruction execution apparatus.

The logics of the exemplary customer support system 110 depicted in FIG. 2A may be executed by one or more processors 245, such as one or more central processing units (CPU), digital signal processors (DSP), graphics processing units (GPU), application-specific integrated circuits (ASICs), field-programmable gate arrays (FPGAs), and/or microprocessors programmed with software or firmware, other specialized processor or combination of processors, or other circuitry that communicates to and drives the other elements within the system 110 via a local interface 205, which can include at least one bus, such as I2C, SPI, USB, UART, or GPIO. As an example, the processor 245 may execute instructions of software stored in memory 210, or subsets thereof. While FIG. 2A illustrates one processor 245 that implements all of the various logics in the system 110, it is possible in other embodiments for the system to employ multiple processors. In one such alternate embodiment, discrete processing elements may be used for each of (or any subset of) sentiment analysis logic 124, workflow logic 220, autoencoder 240, control logic 222, and communication logic 224, or any portions or subsets of those logics. In some embodiments, the processing of system 110 is not limited to being performed by a processing element connected to the local interface 205, but instead, any portion of processing in support of the various logics or models may be distributed over one or more computer systems that may be remotely located. For instance, system 110 may include physical computing devices residing at a particular location or may be deployed, wholly or partially, in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). In some embodiments, the processor 245 may include an artificial neural network or other type of configuration for performing machine learning functions based on instructions stored in memory 210.

Memory 210 may also contain user data 231, workflow data 232, survey data 233, thematic response data 234, and vector data 242, which respectively include one or more databases storing information used by sentiment analysis logic 124, workflow logic 220, control logic 222, and/or communication logic 224. It will be noted that while the term “database”, “data”, “repository”, or “data storage” may be used herein with reference to elements 210, 230-235, or 242 or the data structures therein, these components are not so limited nor is any particular form, number, or configuration of data storage mandated, and any of the described “databases” may alternatively be an indexed table, a keyed mapping, or any other appropriate data structure or repository.

Each of the data in repositories 231-235 will be described below in turn with reference to FIGS. 2A and 2B. In FIG. 2B, five categories of data 231-235 are illustrated, each corresponding to one or more tables or other data structures that can be queried. Other embodiments may include any number of categories, and any number of data structures. In an exemplary embodiment, the data between items 231-235 may include some amount of redundancy, as some user actions may be relevant to several categories of data, however in other embodiments, the data is unique to each category 231-235.

With reference to FIG. 2B, user data 231 may include information associated with a user, e.g., user ID, user account information (e.g., name, contact information (e.g., email address, mailing address, telephone number), date of birth, payment card information), a type of user (e.g., guest/registered, business/vacation travelers, etc.), length of membership, booking history, demographic data about the user, such as age, gender, location, language, and device information, GPS, IP address, or location data, operating system, browser, or other device data, user preferences or interests, connected third party accounts (e.g., social networks) if applicable, and the like.

Workflow data 232 includes a variety of information collected as users interact with a website or app, make transactions, and the like. Therefore, each of the entries in workflow data 232 can be associated with a particular user or user device, for example, a user ID (if logged in), a device (by device ID, IP address, MAC address, or the like), session ID, other information sufficient to identify a user (such as a unique code or password), or any other appropriate identifying mechanism. In an exemplary embodiment, data regarding a user's activity is pulled from one or more of web server(s) 140 and external databases 250 to populate workflow data 232 in real-time, in response to any action by the user or any of one or more scheduled events. Alternatively, data may be pulled on a scheduled basis, e.g., every one or five minutes, or any other appropriate frequency. In some embodiments, the selected method and frequency of data collection may depend on server computing resources, transmission latency, frequency of activity in the relevant market, a user base size, seasonality or changeability of data, and/or other relevant considerations.

Workflow data 232 may also include landing data, that is, an entry point for a user such as a first landing page displayed to a user when accessing a website or app, upon which landing a unique session or workflow ID is created. The landing data and the data of any other screen or user interface interacted with or visited by the user may be referred to as screen data. Where the user interacts with fields of data such as hyperlinks, buttons, search bars, filters, pop-ups or persistent messages, chat features or messaging options, drop down menus, search fields, radio buttons, maps, sliders, point-and-click interfaces, or other user interface components, this data may be stored as click data in database 232. In some embodiments, web server logs may contain information that allow sites to determine what sites referred the visitor to the present site, what pages a visitor viewed and when, or client IP addresses (which can roughly approximate location). Depending on the structure of the URL of the referring site, additional information can be identified (e.g., where a user's search is included as a character string in a search engine referral address). Web server logs can also contain information as to which web pages a user has visited and the order of a user's traversal through a website.

Workflow data 232 may also include, in some embodiments, engagement data or site activity data regarding how users interact with a website or application. In an exemplary embodiment, this data could include any of click or view data on links, advertisements, images, listings, pages, and so forth, actions such as liking/disliking, bookmarking, saving, marking as favorite, adding or editing wishlists, scrolling, or other actions (or transactions) made by the user. In some embodiments, this engagement data may also include cumulative or calculated data based on the user's interaction with the website/app, such as an amount of time spent on a single page, listing, or website (or timestamps from which such time can be later determined), each visitation or view (from which a frequency of visitation or views can be later determined), referrals made, region(s) of searches and/or bookings, minimum, maximum, and median prices of the properties browsed, or any other relevant collected information. Additionally, in some embodiments, engagement data may include third-party data such as social media interaction with or regarding the website or app provider, such as shares, tags, comments, referrals, and the like (such third party data being collected from external servers 250. In some embodiments, activity data can be collected from server logs as users visit pages, from server application software which generates the requested pages, and/or by client software such as JavaScript or mobile applications that can detect user actions (e.g., hovering over images, watching videos, and/or tracking the amount of time particular areas of a listing or search results are displayed in the display area, among other things).

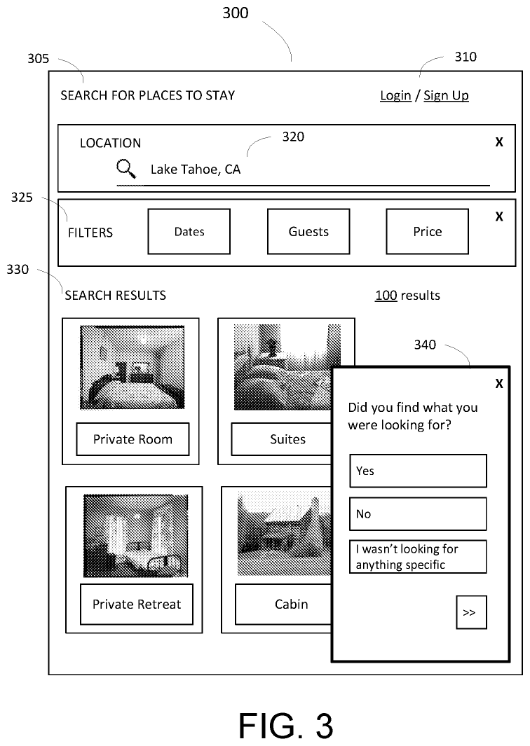

Survey data 233 may include data entered by the user into a customer support interface. For example, a user interface may be presented to the user in the form of a persistent survey or chatbot. In an exemplary embodiment, this interface is a chatbot application or window that hovers over content presented to the user as shown in FIG. 3. As illustrated, chatbot interface 340 is a window presented to the user over the user interface 300 (the browser window or application). With reference to FIG. 2B, survey data 233 may contain a unique survey or chat ID, which may be associated with the session ID and/or the user ID. In an exemplary embodiment, all content entered by the user into the survey interface, such as freeform unstructured text, selected structured text, hyperlinks, documents, or the like, is stored as survey data 233. This may include a last string (or selection) value or data. As described in greater detail below, one or more sentiment scores may be calculated during an interaction with the user. In one instance, a single sentiment score may be generated based on the last string (or input) entered by the user, or a last string sentiment score. In another instance, a delta sentiment score (or ΔSentiment) may be generated to indicate an overall sentiment score for an ongoing interaction with a user, which interaction may include one or more user inputs and/or one or more responses. Changes to this delta sentiment score (that is, whether the sentiment of the user is improving or declining, and the degree of change) may also be calculated and stored. In some embodiments, stored input, response, or combinations of one or more inputs/responses may be reduced and stored as vector data which can be better analyzed as described herein. Accordingly, survey data may contain one or more vector IDs to information stored as vector data 242. While in FIG. 2A vector data 242 is stored separately from database 230, in other embodiments the storage of vector data 242 may differ.

Thematic response data 234 may include data generated by the system 110 that can be used in response to data input by the user in a survey interface that requires a real-time response, such as a chatbot or messenger application. The term “thematic” is used herein to describe data that can be organized or associated with a theme or classification. Such themes or categories are intended to conform with topics on which a user may seek customer support. As one example, where system 110 is a customer support system for use with an website facilitating an online reservation platform, such themes or classifications may be, for instance, “user”, “user account”, “payment”, “booking”, “cancellation”, “confirmation”, and so on. Of course, the foregoing is merely exemplary, and different websites or applications, or other solutions, may require different breakdowns of categories. In some cases, the themes may conform to product names or IDs, features, software releases, testing efforts, or the like. Each theme may be identified by a unique theme classification ID. As thematic response data 234 may contain all possible response data for display to the user, any subset of data, sharing a common classification ID, can be understood to contain all possible response data relating to the theme or classification in which the user is seeking customer support. For example, where the user is seeking support on a payment question or problem, system 110 may obtain from thematic response data 234 any of all of the set of possible responses regarding “payment”.

Each of these responses may be associated with a sentiment value, such that they may be associated with data identifying the response as a positive sentiment response, a negative sentiment response, or a neutral sentiment response. In general, it may be understood that a positive sentiment response would be presented to a user where the user input has been analyzed to determine that the user sentiment is currently or overall positive. Negative and neutral sentiment responses may be understood correspondingly. Thematic response data 234 may also contain threshold data that would define the boundaries or ranges under which a calculated sentiment score would be considered positive, negative, or neutral. Other embodiments may use different sentiment categorizations (e.g., strongly or mildly positive/negative, etc.). Finally, the thematic response data 234 may also contain suggested response data, that is, a “next” or “upcoming” response that is recommended to be presented to a user via the customer support interface (e.g., chatbot or messenger app), or other action to be taken, based on an evaluation of the context and sentiment of user input text.

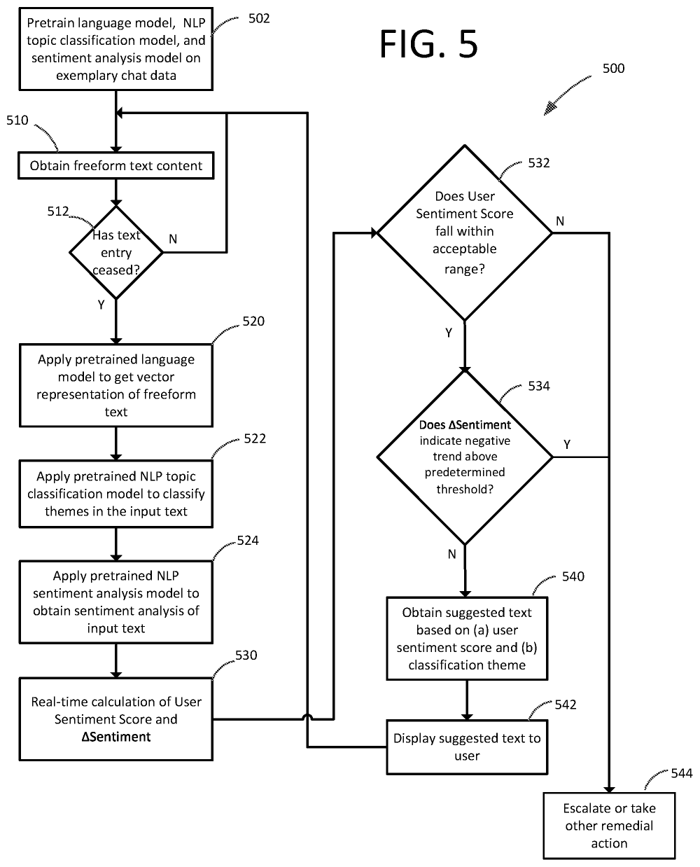

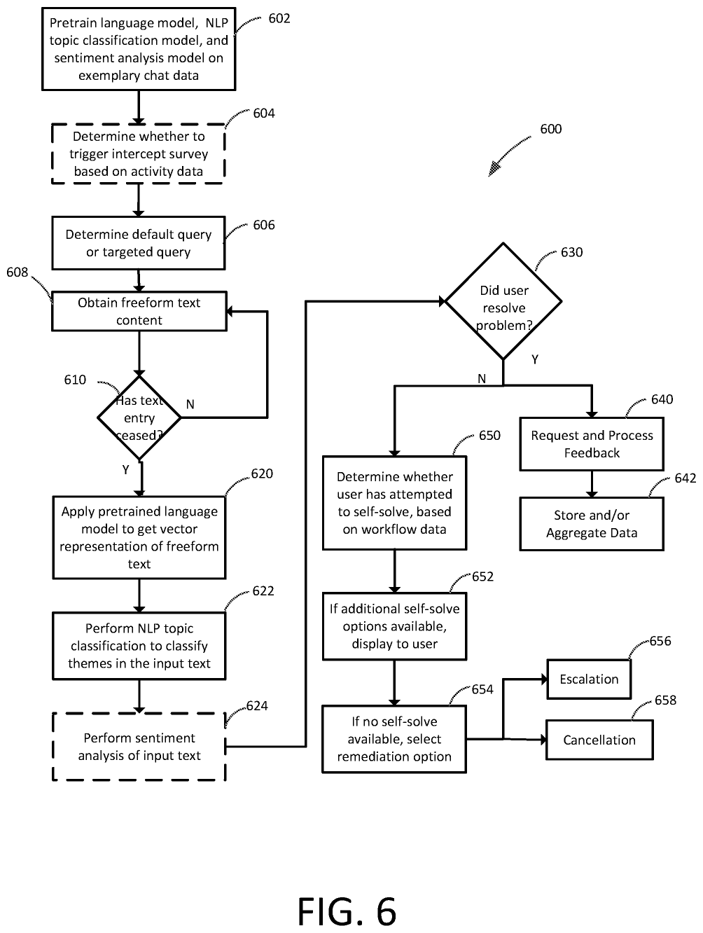

Information in vector data 242 may include information sufficient to uniquely identify one of more vectors or other encoded representations of a sentence, word, or character string generated from the freeform text data input by a user, as well as the one or more associated vector/encoded representations. This data is evaluated in real-time via one or more machine learning algorithms for purposes of content classification and/or sentiment analysis, in a manner described in greater detail below with respect to FIGS. 5 and 6.

With reference to FIGS. 3-6, one goal of the systems and methods described herein is to increase coverage of user feedback and to evaluate freeform text input by a user to find implicit signals of customer satisfaction. That is, given freeform text entered by a user via an interface on a website (e.g., a chatbot or messenger) the user's sentiment can be derived in real-time, and appropriate actions can be taken or recommended to the user. This interaction is done before the initialization of a help ticket and without the need for explicit questions in a post-event survey. The derivation of user sentiment is performed through one or more machine learning algorithms, and the model-predicted sentiment can be used as a real-time indicator for customer satisfaction.

Exemplary embodiments are described herein with reference to FIGS. 3-6. With reference to some embodiments, a customer support system 110 may be understood as a system for taking in requests for customer support from users of a web-based interface, resolving the outstanding issues, either by assisting a customer in self-solve support actions or escalating through a systems-level support group, and/or generating metrics based on aggregated customer support data. The customer support system 110 may take a freeform text input string or query from a user and retrieve text-based (or in some cases, document or hyperlink-based) responses that have high topical relevance to the input string or query. The relative responsive content may in some embodiments be selected from within a larger corpus or collection of potential responses. The retrieval of this information is performed based on a holistic analysis of the user's textual input in the query. To accomplish this, one or more semantic classification models may be applied to the textual input. In an exemplary embodiment, such models may include a topic classification and/or intent classification model, implemented by example through a keyword extraction method. In an exemplary embodiment, such models also include a sentiment analysis to detect an overall satisfaction of the customer as well as a sense of urgency or importance. The returned responsive content may be one or more (or any combination of) textual responses, hyperlinks, download links, selection buttons, or the like, each respective response offering or seeking information that may assist with the resolution of the customer support issue. The returned responsive content need not be a uniquely generated response to the user's exact query (though it may be), and in some embodiments may instead be a predetermined response (from a database of responses) that is contextually-related to the user's query, while also being selected or modified based on the user sentiment analysis.

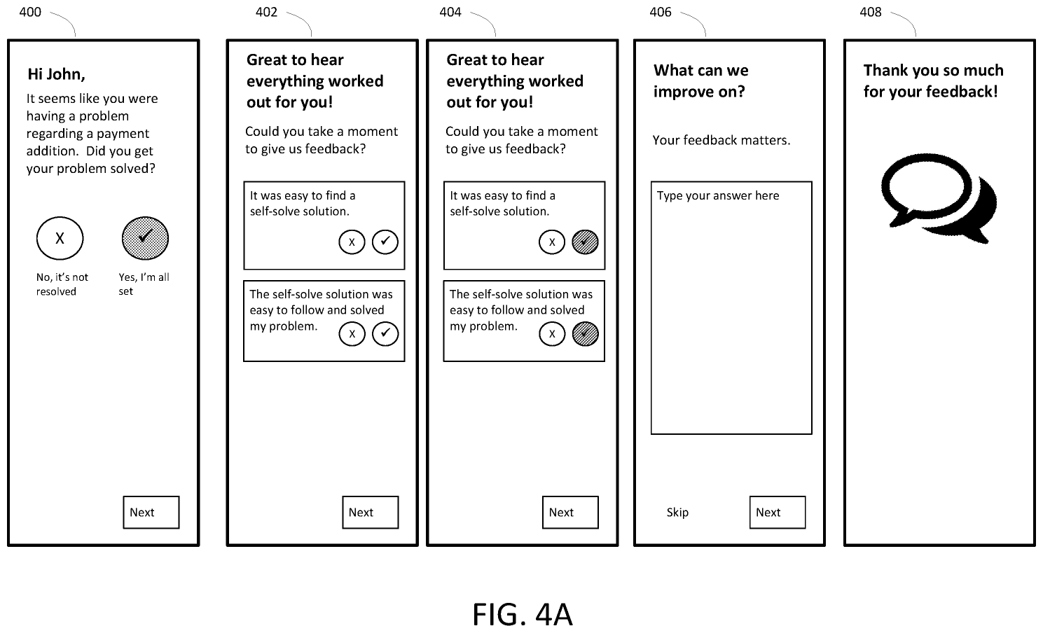

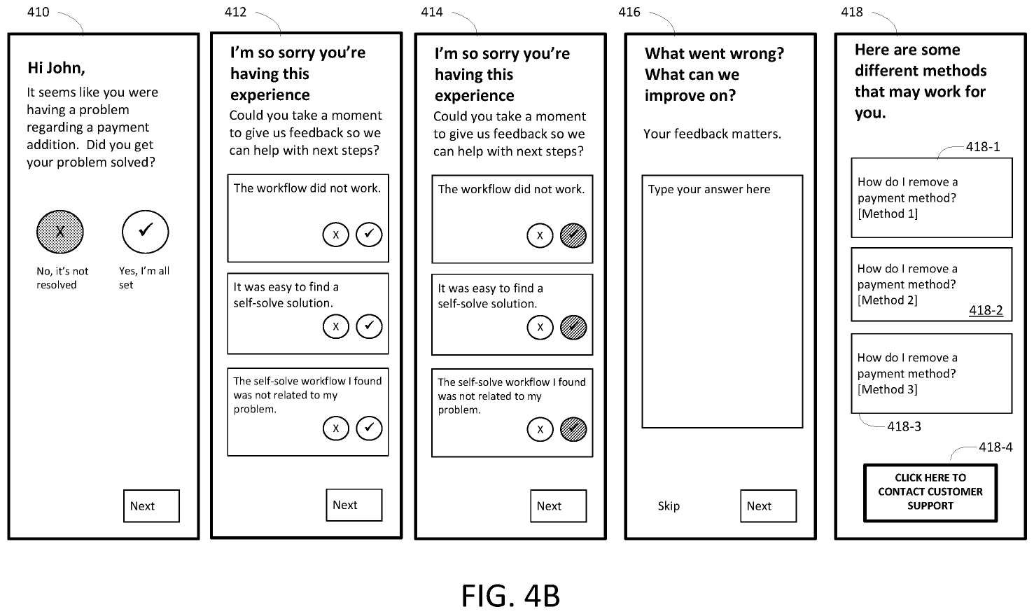

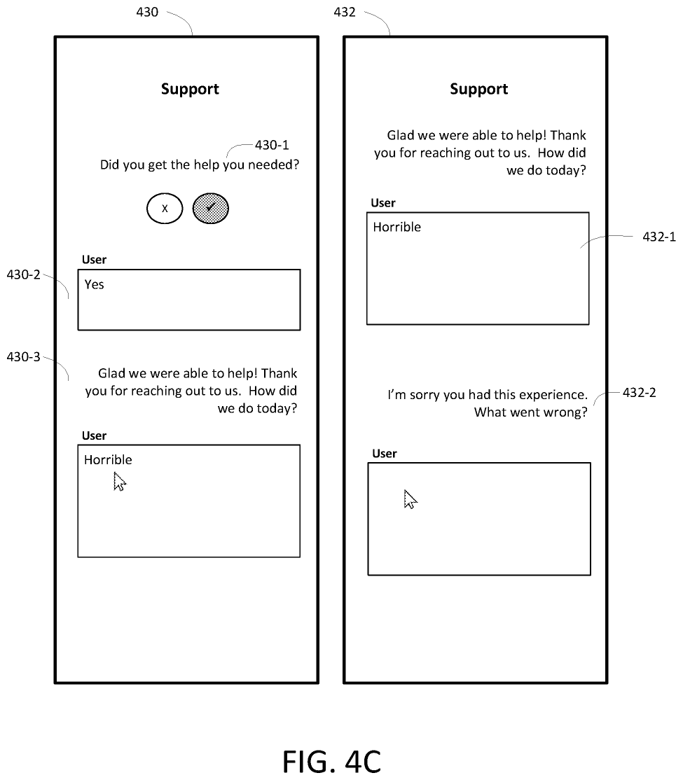

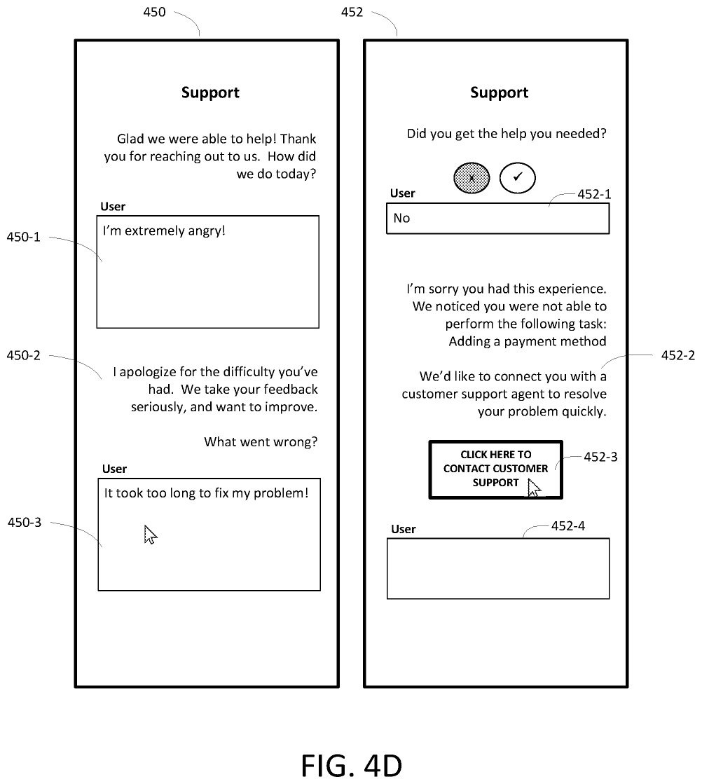

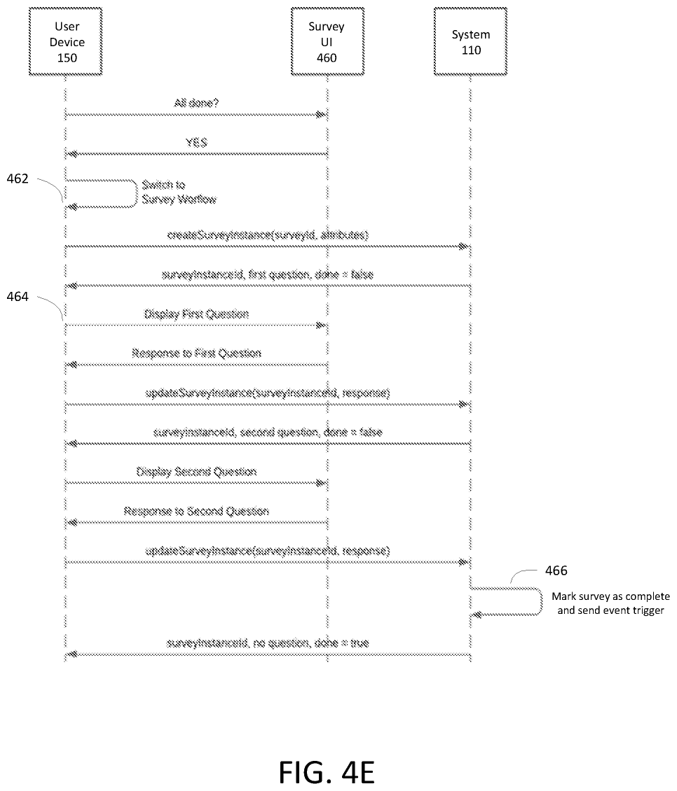

For example, in some embodiments, the systems and methods described herein are directed to the creation of a conversational interaction for a chatbot to be presented on a website. The chatbot supports the output of questions and the intake of answers in a native chat format. In some embodiments, the systems and methods described herein are further directed to the collection and analysis of interaction results. FIG. 3 illustrates such a chatbot interface 340, superimposed so as to “float” or persistently remain on top of the website screen 300. In the example of FIG. 3, the user is using interface 300 to search for and book a temporary stay, such as a hotel or housing rental. The user may or may not have logged in (element 310), which log in would tie the user's session (designated by a session ID) to particular user account information stored as user data 231. The user may have engaged in search, navigational, or other activity during their session. For example they may have searched (field 320) a location, filtered (field 325) on any number of granular filters, such as date of stay, number of guests, price, and so on. The user may also have clicked on one or more of the displayed results 330. Each of these navigational, click, search, or other interactions may be stored as workflow data 232 in association with a session ID (and/or in some cases, a user ID). FIGS. 4A-4D describe various progressive interfaces that may be displayed to the user and updated in real-time, for example through chatbot interface 340 or similar type of interface. FIGS. 4A-4D will be described in greater detail herein with reference to FIGS. 5 and 6.

FIG. 5 depicts an exemplary sentiment analysis process 500 performed by the sentiment analysis logic 124 and the autoencoder 118, sometimes in combination with workflow logic 220 or other components of customer support system 110 in accordance with some embodiments of the present disclosure. In general it may be understood that the exemplary process 500 is intended to address two problems preexisting in the conventional solutions: first, how to measure the sentiment (and changing sentiment) behind a user's real-time customer support feedback, and second, how to act upon such measurements in a meaningful way. The first problem is addressed by measuring implicitly the sentiment behind what is typed during a user's interaction and input of freeform text rather than (or in complement to) a post-action survey. The second problem is addressed by tying the selection and delivery of self-serve workflows or suggested actions and responses to user sentiment.

The process begins at step 502 in which one or more machine learning models have been trained on a set of character string data simulating potential input text typed in by a user. This training data may encompass text directed to a variety of topics and a variety of languages, formality of speech, and so on, so as to provide a variety of possible input text. The set of training data is vectorized and machine learning algorithms are applied to the training data. A vector may be understood to represent a variety of information about a sentence. This may include any or all of, e.g., semantic characteristics (what the sentence means), the tokens (words and/or punctuation) in the sentence and what they mean in the context of each other and in the sequence of tokens, and other appropriate contextual information. This data is stored to memory 210 and/or to disk, depending on the size of the dataset and the computational limits of the system 110. The machine learning models extract features from this training data to develop one or more trained models capable of sentiment analysis and topic classification. In an exemplary embodiment, the NLP models may be trained on the training set on a periodic or scheduled basis, for instance daily, weekly, monthly or the like, or in real-time, depending on the size of the collection and the frequency of relevant change within that collection, to optimize the weighting applied by the various ML (machine learning) models applied to the systems described herein. The training generates a pre-trained model that can be used in a run-time application to pre-compute representations for individual, varied length sentences in a dataset which can be used in subsequent steps, such as measurements of sentiment.

In step 510, a user interface is displayed to a user and a freeform text input (query) by the user is obtained in response. This input by the user is received in real-time, so the system 110 must be consistently listening to determine whether text entry has ceased (step 512), meaning the user has completed their response, or additional information is being added. For instance, even where a user may press a “Submit” button to transmit input text (e.g., in a chatbot messenger application or other widget), the user may thereafter enter one or more additional text inputs immediately thereafter. As all of these separately submitted character strings should be considered part of a single logical input by the user, the process circles between step 510 and step 512 until such input is complete.

An example of one such interface is illustrated with reference to FIGS. 4A and 4B. FIGS. 4A and 4B each depict a user interface (400 and 410, respectively) which inquire whether the user's problem was solved. These UIs may be generally understood as intercept surveys, that is, surveys presented during the user's workflow or progression through the website or application. In FIG. 4A, the user's problem was resolved, and a progression of screens is displayed in which system 110 requests additional information from the user (402), takes in additional input from the user (404), requests free-form text input with user feedback (406), and ends the interaction (408). In FIG. 4B, the user's problem was not resolved, and a different progression of screens is displayed, though the general process of requesting (412) and receiving (414) information, and requesting freeform input (416) remains. On UI 418, rather than ending the interaction, system 110 displays options for self-solve actions 418-1, 418-2, and 418-3, as well as a button 418-4 to facilitate escalation from a self-solve solution to an agent-implemented solution.

Other example user interfaces are illustrated with reference to FIGS. 4C and 4D, which depict user interfaces presented to a user at the end of, or subsequent to, a workflow. These UIs may be generally understood as post-event surveys, which are intended for feedback purposes rather than to drive workflow in the immediate session. In FIGS. 4C and 4D, rather than a progression of screens, the illustrated UI is a scrolling interface, as with modern chat or text messenger applications or widgets. As additional input and response is transmitted and displayed, the newer responses are added to the bottom of the chain.

The screens of FIGS. 4A-4D are merely exemplary. The particular form of the input mechanism, e.g., via website, intercept or post-action survey form, chatbot or other bot, messenger app, text entry widget, text message or SMS, and so on, is unimportant so long as the response can be received any processed in real-time. Accordingly, the user interface through which the input is received may be arranged in any suitable manner and with any appropriate elements in various embodiments.

In one embodiment, control logic 222 and/or communication logic 224 are executed by processor 245 to provide to web server 140 a graphical user interface to be displayed on user device 150. Web server 140 may present to the user device 150 a user interface through which one or more document constraints can be accepted. FIGS. 3-4D illustrate exemplary user interfaces through which a variety of input can be entered by the user of device 150. Web server 140 (or a component of system 110) may extract, from the input data, various information about the input text and/or other values including, in an exemplary embodiment, the actual content of the query input string (in some embodiments, in a tokenized format). In addition to freeform text data entered, the data obtained from web server 140 may also variously include information sufficient to identify the user, such as a user ID (if the user is logged in or otherwise authenticated) or a session ID, as well as the particular text input by the user. The input text is transmitted from the web server to customer support system 110 and processed by the autoencoder 240, sentiment analysis logic 124 and/or workflow logic 220.

Referring back to FIG. 5, in step 520, the trained ML model is applied to the input text as to the text of the training set, and vector representation(s) of the text input is generated. The autoencoder 240 is applied in step 520 to generate a series of vector representations from and representing textual sentences or phrases. A corpus of text is stored as individual string inputs in memory 210, for example, as survey data 233, or in a separate memory or hard disk. In an exemplary embodiment, autoencoder 240 vectorizes every input string stored in survey data 233. The vector representations are then stored in memory 210 (or in a separate memory or hard disk) as vector data 242, each vector being stored in association with a unique vector ID relating the vector to its initial input string. The specific method of generating the vector from the textual input may be performed through any of a variety of known methods. In one exemplary embodiment, Google's BERT (Bidirectional Encoder Representations from Transformers) model or a model based on BERT, such as XLM-RoBERTa, may be used as an applied natural language processing (NLP) model. However in other embodiments, any other appropriate pre-trained model (e.g., Generative Pretrained Transformer (GPT), Text-to-Text Transfer Transformer (T5), ULMFiT, etc.) may be used.

Steps 522 and 524 are directed to the application of machine learning models to classify themes and analyze sentiment respectively, based on the text input by the user. In step 522, a topic classification is performed to determine the semantic meaning of the input text. In one embodiment, the user may, in a plain text sentence, phrase, or passage, reference a concept or description connecting the input to a particular scenario, circumstance, product, problem type, or the like. Rather than a boolean search or filtered search (e.g., where the user selects keywords, categories, or characteristics), a machine learning analysis is performed on the free entry of text in the user's natural language. This input may be used by sentiment analysis 124 to obtain from a database one or more responsive text results that are contextually related to the content of the freeform input, without having to identically or explicitly match word-for-word content in such stored data.

In an exemplary embodiment, text classification or topic extraction from text is performed by one or more supervised or unsupervised algorithms. In some embodiments, this may involve feature extraction from freeform text e.g., to generate vectors for words or sentences. Topic classifiers are defined in advance, and stored in memory 210 as thematic response data 234. As examples, some predefined topics may include: “user account”, “payment”, “booking”, “cancellation”, “confirmation”, and so on. The specific topics can be generally understood to be specific to the purpose and use of the website or application. In some embodiments, the predefined topics may correspond to products, ticket topics or identifiers, or other delimiters created by a backend customer support system. For each of these topics, one or more machine learning models may be applied to detect patterns in the input freeform text that suggest relevance. For example, for “payment”, the models might detect patterns such as currency symbols, numbers, related words such as credit/debit, expensive/cheap, refund, bank, worth, price, account, and/or combinations of words in particular relevant order and/or structure. The models would then label the corresponding text in the input string appropriately. In some embodiments, exemplary algorithms are NLP topic classifications models such as Latent Semantic Analysis (LSA), Latent Dirichlet Allocation (LDA), and/or other text classification algorithms such as Naïve Bayes, Support Vector Machines (SVM).

The topic analysis may be applied at one or more of a sentence level (i.e., for each individual input by the user), at the field level (i.e., for the whole of a single query or response entered in an input field by the user in a back-and-forth conversation via a chatbot or messaging app, or in another written survey response). In some embodiments, the topic analysis may additionally be applied at the session level, where the topics defined by the user's text input are refined, altered, rewritten, or otherwise revisited in view of the holistic whole of the inputs by the user during the session.

In an alternate embodiment, an unsupervised machine learning technique may be used to cluster expressions and derive topical relevance without pre-definition of topic tags. In other embodiments, rather than a machine learning technique, one or more rules-based systems may be applied to perform a topic classification task, for example by using predetermined lists of words associated with topic classifiers and recognizing the presence or absence of such words in the user's input. In still another embodiment, a topic of the user's input may be actively selected by the user from a presented set of topics displayed on the user interface, e.g., as selectable buttons.

In some embodiments, the ML models described above are not limited to the text input by the user and may additionally or alternately use historical data regarding the user's prior interactions with the system 110. For instance, in a first customer support instance, a tone (or style) of response (e.g., language, formality, linguistic traits) may be detected, and an identifier for such a tone of response may be stored in memory 210 in association with user data 231. Upon the initiation of a subsequent session with the same user (recognized, e.g., by login information, IP address, device ID, or so on), these identifiers may be accessed and used to evaluate text responses presented to the user. Additionally, other user profile data (such as location data (e.g., device of IP data), demographic data, prior customer support history (e.g., frequency of problems), and so on) and other circumstantial data (such as time of day/night, location of purchase or booking, type of device used for interaction, and so on) (e.g., user data 231) may feed into recognition of a type of issue. As just one example, in the case of a website that facilitates property bookings, it may be assumed that a user logging in from a home computer several weeks in advance of a booking may have a different type of query than a user logging in late at night from a mobile device or borrowed device on the evening of a booking, even where both users use similar words in their query, such as “payment” or “confirmation”. These additional factors may be considered within the ML models described above, for example in a weighted regression analysis where the sentiment analysis of the written text is weighted more strongly than circumstantial factors.

As an output of step 522, one or more topic classifiers may be assigned to the user input string. These classifiers may be used in step 540 to filter and select a set of potential textual responses to the user query or input. For instance, the corpus of possible responses in thematic response data 234 may input textual responses related to a variety of classifiers; that is, a response for anything the user may ask or say. The entire set of possible responses may be filtered based on a classifier (with reference to FIG. 2B, a theme classification ID), to obtain a subset of possible responses. These responses may be further filtered and/or selected from, based on a sentiment analysis performed in step 524, as described below.

In step 524, a sentiment analysis is performed on another vector representation derived from the freeform text input, or in some embodiments the generated same vector(s) used in step 520. Every time the user interacts with the interface, thereby providing more input data to the web server 140, a sentiment analysis is performed to derive signals regarding user sentiment. This sentiment analysis is conducted via NLP methodology based on the user's freeform text entered into a chatbot. For each user response, a sentiment score is determined. That is, a sequence of sentiment scores is obtained at a fine level of granularity, and can be used at different levels of aggregation. For example, delta changes in sentiment can be obtained over the course of a chat conversation. Therefore, for example, over the course of an interaction, with several back-and-forth communications between the user and system, a user's sentiment can be measured to improve, and by what degree. Lowered sentiment can be compared to a bottom threshold value or limit, and when that limit is exceeded (e.g., the value falls below the threshold), the system may understand the customer support efforts to be upsetting or unsatisfactory to the user. Accordingly, the system may take steps to modify the manner of interaction with the user, for example by changing the channel of the interaction, such as escalation of the issue to an actual person, or taking other action such as approving cancellations or returns, or other traits that would allow the issue to be resolve expediently prior to any argument or negative review or action by the user. In an embodiment where a survey may be conducted after a customer support activity is complete (e.g., by email or text or form submission), this real-time sentiment analysis during chat interaction is performed in addition to, and is not a replacement of a subsequent survey.

In an exemplary embodiment, sentiment analysis from text is performed by one or more supervised or unsupervised algorithms. In an exemplary embodiment, a transformer-based deep learning technique is used for sentiment analysis and other large scale NLP processing tasks. The transformer may be trained on the dataset described above with regard to step 502. Exemplary transformer models may include XLM-RoBERTa, or other models based on BERT. In some embodiments, sentiment analysis task is modeled as a classification problem, whereby a classifier is fed a text input and returns a category, e.g. positive, negative, or neutral. This may involve feature extraction from freeform text e.g., to generate vectors for words or sentences. Exemplary classification algorithms are NLP classification models such as Naïve Bayes, Support Vector Machines (SVM), and/or linear regression techniques. The output of the models is a probability distribution across different sentiment categories, then a sentiment score is generated based on the distribution. In other embodiments, this score may then be compared to a range of possible scores to classify the sentiment as positive, negative, or neutral. In some embodiments, other classification schemes may be used, e.g., highly/slightly positive/negative. In an exemplary embodiment, the sentiment score is a value from 0-1, with 0 being the most negative, and 1 being the most positive.

The calculation of such a sentiment score is performed in step 530. Each time the user submits an additional character string, a real-time sentiment analysis may be performed thereon, and a sentiment score is calculated, reflecting the user's current satisfaction or happiness. Where more than one text input has been submitted by the user (that is, second and subsequent inputs), step 530 may also involve the calculation of a delta sentiment (Δsentiment) or change in sentiment after the submission of each input. This delta sentiment value reflects a change in sentiment between the previous user input and the most recent user input. Where the value is positive (or above a certain threshold), the user sentiment is considered to improve. Where the value is negative (or below a certain threshold), the user sentiment is considered to have degraded (i.e., the user's experience is worsening and they are being increasingly unhappy). Where the value is zero (in within a predetermined range), the user sentiment is considered to have remained stable. The delta sentiment value reflects a trend in sentiment over the course of the interaction. In some embodiments, the delta sentiment score is overwritten when each subsequent input is evaluated, and in other embodiments, a series of delta sentiment scores is retained and stored in memory 210, so that the user's changing satisfaction can be evaluated over a longer period of time.

In yet another embodiment, an aggregate user sentiment score is maintained in memory 210 and updated in view of the newly-determined user sentiment. The aggregate user sentiment score may be any of, for instance, an average score, the latest calculated score, a series or chain of scores, or any other appropriate value that would reflect an overall user sentiment for the interaction.

In an exemplary embodiment, the sentiment score model is trained on multi-language messages. Multilingual models are therefore preferred, although any model used may be trained on multilingual or monolingual data. In an exemplary embodiment, the NLP model (and in some cases, the topic classification model) used may support, e.g., 100 languages. Accordingly, user input in a variety of written languages, or in mixes of languages, may be recognized and analyzed. In other embodiments, rather than a machine learning technique, one or more rules-based systems may applied to perform a sentiment analysis task, for example by using predetermined lists of words associated with sentiment classifications (positive, negative, neutral) and recognizing the presence or absence of such words in the user's input, or other linguistic NLP methods.

In some embodiments, the ML models described above are not limited to text directly input by the user into the chatbot and may additionally or alternately use historical data regarding the user's prior interactions with the system 110. For instance, in a first customer support instance, a tone (or style) of response (e.g., language, formality, linguistic traits) may be detected, and an identifier for such a tone of response may be stored in memory 210 in association with user data 231. Upon the initiation of a subsequent session with the same user (recognized, e.g., by login information, IP address, device ID, or so on), these identifiers may be accessed and used to tailor the tone of text responses presented to the user. These additional factors may be considered within the ML models described above, for example in a weighted regression analysis where the sentiment analysis of the written text is weighted more strongly than circumstantial factors.

Steps 532-544 involve an application of the sentiment analysis of step 530. This application involves the generation and display of a responsive text message to the user (via user interface 155). The generation may involve additional actions, such as may include, for example, a tailoring/modification of a tone of language used in a response, the display or communication of a routing point, an escalation to an agent (e.g., to a human or AI mediator), or the direction of the user to a different workflow (e.g., a self-solve workflow). In the case of an intercept survey, messaging application, chatbot, or the like presented while the user is attempting to accomplish a task, the information generated and displayed to the user will typically be directed to either completing a self-solve workflow, or directing the user to a third-party agent to complete an agent-based workflow. In some instances, the responsive text may seek additional information from the user.

The content of this responsive text for transmission to the user can be tailored in view of the sentiment scores, as well as other historical data, to present responses to the user that will most effectively convey information while being well-received. Put another way, these steps use the calculated sentiment score (as well as the determined semantic meaning of the text) to evaluate and select a tailored next course of action from a plurality of options. In addition, the selection of a responsive action may include a rules-based contextual analysis, based on, e.g., the time of day, the location, or other circumstances of the user.

In step 532, system 110 determines whether the user sentiment score calculated in step 530 falls within an acceptable range, such range being predetermined and stored in (or accessible by) memory 210. If the sentiment is within an acceptable range (Y in step 532), the process proceeds to step 534, in which it is determined whether there has been a negative change in the delta sentiment value that would exceed a predetermined threshold. If the delta sentiment is acceptable (e.g., not trending downward or significantly downward) (N in step 534), the process continues to step 540.

In step 540, system 110 obtains suggested responsive text from the database of thematic response data 234 based on and the determined classification theme. That is, the responsive text is selected based on a tailored analysis of user sentiment. Thematic response data 234 may contain threshold data that would define the boundaries or ranges under which a calculated sentiment score would be considered positive, negative, or neutral. Other embodiments may use different sentiment categorizations (e.g., strongly or mildly positive/negative, etc.). Additionally, thematic response data 234 may contain all possible response data for display to the user, each possible response being associated with a range of sentiment score (e.g., positive, negative, or neutral) and with one or more predefined topic classifications, e.g., “user account”, “payment”, “booking”, “cancellation”, “confirmation”, and so on. Based on the contextual topics or themes of the user input (determined in step 522) sentiment analysis logic 124 may filter this possible response data to a subset of data relating to the relevant topics on which the user is seeking customer support. From this subset of responses, any responses associated with the appropriate sentiment classification are considered the set of “suggested text” for display to the user. In other embodiments, rather than selection of an existing suggested response from a database, a text responsive may be generated dynamically based on the contextual analysis performed in step 522. One or more of these suggested text values are selected (step 540) and displayed to the user via user interface 155 (step 542). Once displayed, the process circles back to step 510 at which point the system 110 listens for any user input.

In some embodiments, one or more possible responses may exist in that subset of data for each of the different sentiment categorizations, but in other embodiments, a default response may exist along with one or more alternate responses, and a rules-based system may be applied to determine if any response other than the default should be displayed. In some embodiments, the suggested text may in fact be a series of responses that may be displayed to the user either serially or all at once as a plurality of options between which the user can select. In the case that the suggested response is a series of text strings for display to the user, any intermittent user input submitted during display of these responses may, in some embodiments, interrupt the display of the serial responses and initiate a repeat of process 500 from step 510. In other embodiments, the serially-presented responses may be displayed in full before addressing the new user input.

An exemplary difference in possible responses based on a sentiment determination can be seen with reference to FIGS. 4C and 4D. FIG. 4C's snapshot 430 of the UI illustrates a collection of feedback that asks primarily for freeform text input from a user. After an initial inquiry of whether a problem was solved (430-1), the screen receives a user input of “yes” (430-2), or in other embodiments, a selection of a button indicating a positive or negative response. Based on input 430-1, the NPL models of sentiment analysis logic 124 may determine that the user sentiment is positive, and may select from thematic response data 234 a positive response (4303). As shown on screen 432, in response to text 430-3, the user inputs a text string of “Horrible” (432-1). Based on a real-time sentiment analysis of the response, the sentiment analysis logic 124 may defer from its planned series of inquiries, and instead select from thematic response data 234 a “negative” response (432-2), or more specifically, an apologetic or problem-solving response. This negative response 432-2, contains language (“sorry”) that is tailored to the user expressed sentiment. In screen 450 of FIG. 4D, the user's initial input (450-1) can be interpreted by sentiment analysis logic 124 to express a strong negative sentiment. In such a case, the suggested user response (450-2) from thematic response data 234 that is displayed on screen 450 is tailored from the outset to the client's negative sentiment and provides the client with an opportunity to enter freeform text (450-3) to describe the reason for the client's negative sentiment. In screen 452 of FIG. 4D, the user's initial input (452-1) in response to an inquiry as to whether the client received the help that was needed is received. The user's input 452-1 can be one or both a user input of “No” and a selection of a button indicating a negative response. The sentiment analysis logic 124 can interpret the user's input 452-1 to express a negative sentiment. In such a case, the suggested user response (452-2) from thematic response data 235 that is displayed on screen 452 is tailored from the outset to the client's negative sentiment (e.g., a “negative” response, or more specifically, an apologetic or problem-solving response). In addition, rather than ending the interaction, system 110 displays an option (e.g., a button) to facilitate escalation from a self-solve solution to an agent-implemented solution (452-3) or to provide additional commentary on the situation (452-4). Of course, the text and responses shown in these figures are merely exemplary and other embodiments may differ.

Turning back to FIG. 5, if the sentiment is outside of an acceptable range (N in step 532), this would indicate that the user is significantly unhappy with their circumstance and/or the customer support effort. Similarly, even if the user's overall satisfaction is not wholly negative (Y in step 532) a significant negative trend in the delta sentiment value may indicate that the user is growing increasingly unhappy at an unacceptable rate (Y in step 534). In such scenarios, the system 110 may determine to act differently than if the user sentiment was remaining stable. Upon a determination of N in step 532 or Y in step 534, the process continues to step 544, in which system 110 determines to escalate the circumstance, i.e. from a self-solve solution to an agent-based solution, or take another remedial action. The other remedial action may be context dependent. For instance, in an e-commerce setting where the user is seeking support because their booking or purchase is deficient, the remedial action may be a cancellation and/or refund. The escalation or remedial action might therefore involve displaying, via user interface 155, a hyperlink, button, or other mechanism that that user can use to pursue the remedial action (escalation, cancellation, etc.)

In this manner, sentiment analysis logic 124 can be applied to generate and/or modify or tailor responses to user input and questions for follow up, the generation being done on the fly with consideration of user sentiment (e.g., in FIG. 4D, the suggested user response 450-2 of “I apologize . . . What went wrong?”). This is done via an NPL analysis of freeform natural language text input, rather than a decision tree with hard-coded questions and preselected options or buttons for selection. The results of this method are more effective than that of conventional decision trees, where selections guide the process down different branches until a resolution point is reached (and the process restarted if not successful), or later submitted complaints or customer support calls. By virtue of the sentiment analysis processed described herein, a chat point can be presented to the user and signal measurement can be performed based on the customer support interaction itself, and both the quality of questions/response and of customer satisfaction can be improved in real-time. Further, additional information can be considered in both the dynamic generation of questions to ask the user as well as the form and linguistic expression to be used in asking them. The user's freeform responses can be used to dynamically reevaluate the questions to be asked.

In an exemplary embodiment, it is possible for the determination of user sentiment to be predicated on additional data beyond the input text itself. For instance, where the user may (based on their user data/login) be associated with external websites or social media accounts, user-entered text in those mediums may be collected and stored as user data 231 and weighed as another factor in the ML algorithms applied by sentiment analysis logic 124. As just one example, if a user expresses a negative opinion on a public social media application, such data can be collected (e.g., periodically) from external databases 250, and the sentiment analysis logic 124 may thereafter assume that the user begins their interaction with an overall negative sentiment.

In another example, and as described in greater detail herein, the user's session and historical data (e.g., user data 231 and/or workflow data 232) may be used to analyze sentiment, for example screens viewed, buttons pressed, past user purchases, user profile data, including demographic, location and language data, and other such historical and contextual metadata related to the user. Still further, where the website or application with which customer support system 110 is used has other messaging or communication functions (such as chat between members, seller/purchaser, booker/bookee, host/guest and so on, data from text-based threads indicating interactions between these entities may also be used in an analysis of the customer's sentiment. However, in an exemplary embodiment, because a human user's sentiment may change over time, data that is temporally closer to the customer support interaction, such as session activity or workflow may be considered to be more convincing and therefore weighed more heavily than other factors.

Additionally, other user profile data (user data 231) can be used to tailor speech, such as location data (e.g., device of IP data), demographic data and so on. Accordingly, a specifically tailored experience can be provided to a user of a customer support system without the user having to evaluate and select questions to trigger a certain response from the system. Additionally, users who speak multiple or non-local languages, may be afforded better communication and more valuable information in their customer support interaction.

FIG. 6 illustrates a similar process to that of FIG. 5, where the user's session workflow is considered in addition to the sentiment of the user's input. Process 600 may involve an evaluation of whether the user is currently attempting to accomplish a task, and if so, what they have tried and still need to do to accomplish that task (workflow). In the case of an intercept survey, messaging application, chatbot, or the like presented while the user is attempting to accomplish a task, the information generated and displayed to the user can be typically be directed to either completing a self-solve workflow, or directing the user to a third-party agent to complete an agent-based workflow. With reference to FIG. 6, in order to optimize this metric, a personalized workflow can be triggered to optimize user satisfaction metrics. For example, the workflow logic 220 may be applied to suggest a tailored action, such as where to route the user, when to escalate to an agent-based solution rather than a self-solve solution, when to forward the interaction to a community expert, when to connect the user with another person of interest (e.g., seller or host, among others), when to trigger an automated workflow, and/or another customized response.

The process begins at step 602 in which one or more machine learning models have been trained on a training set of freeform user text inputs. The process of step 602 may be generally understood to be similar to that of step 502 (from FIG. 5), though other embodiments may differ.

In some embodiments, a post-activity survey may be presented to the user, for example when the user has ended a session or finished an action. However, in some embodiments, in step 604 (steps indicated in dotted lines are considered being optional), it may be determined whether a customer activity necessitating an intercept survey for support has been triggered. In some embodiments, it may be assumed that a “trigger point” has been reached where the user has intentionally called up a chatbot or other messaging application, for example by clicking a link, pop-up, button, widget, or other UI displayed on their device to initiate a customer support interaction.

The system 110 may also, in step 604, function to recognize circumstances that trigger the presentation of the chatbot (or other UI) from which sentiment analysis and/or workflow analysis can be conducted. In one embodiment, this trigger may be based on a semantic analysis of text entered into a field on a website, e.g., into a messenger app or widget, search bar or other query field, etc. (typically accessed from workflow data 232). As an example, even if the user does not click on a customer support hyperlink, a semantic analysis may recognize the word “help” or “support” or a question (“how do I . . . ?”) input into a search bar and may initiate an intercept survey or chatbot. As another example, a disagreement or question in a text-based messenger function, for example, an interaction between a host and guest or buyer and seller) may be analyzed and a problem detected that would benefit from support intervention (e.g., mediation or resolution). In another embodiment, a survey or chatbot may be triggered by a certain amount of time passing without activity by the user, or an abnormally large amount of time passing for a relatively routine or simple task. In still another example, the system 110 may recognize repeated or circular activity (e.g., cycling between the same screens) that does not move the user's intended (or presumptive) workflow forward. Any of these scenarios may be considered as a trigger point indicating that a user is having difficulty accomplishing a goal, and steps should be taken to proactively display a text-based interactive customer support interface, such as a chatbot.

Steps 606 through 624 are similar to those of steps 510-530, respectively, taking in a freeform text input from the user in the presented customer support interface and applying one or more pretrained machine learning algorithms thereto to derive the context of the user's input and the sentiment expressed therein.

In step 630, it is determined whether the user has resolved their problem or task, meaning they have reached the end of their intended workflow. In some embodiments, this is determined by asking the user directly (as in exemplary FIGS. 4A and 4B). In other embodiments, this is determined through an analysis of the user's workflow in the particular session, including the screens visited, buttons clicked, values entered, and so on (workflow data 232). Between steps 604 and 630, workflow logic 220 is applied to determine how the user has interacted with the website or mobile app and whether a user has successfully completed the workflow the user was attempting to accomplish. This allows for the determination of when to start surveying users and functions to provide insight into users who do not fill out a survey.

If the workflow has been resolved (Y in step 630), the system may simply request feedback (step 640) and store and/or aggregate the provided feedback data, in association with the user data, workflow data, and other relevant information (step 642). An exemplary set of screens illustrating this process is shown in FIG. 4A.

If the workflow has not been resolved (N in step 630), the process continues to step 650, in which it is determined, based on the workflow data, whether the user has attempted any self-solve solution. In FIG. 6, the choice of a self-solve option (step 652) or other remediation option (654) is selected based on the availability of additional self-solve workflows that the user has not attempted. However, this determination may additionally or alternately be based on the calculated user sentiment. For example, where user sentiment is high, the user may be more willing to self-solve, and when user sentiment is low, they may wish for the quickest or easiest resolution, which may be agent-based or other escalated support, or other appropriate actions. In some embodiments, the determination of step 650 may additionally or alternately include the consideration of circumstantial data, such as the time of day, the severity of the problem, and/or other conditions. For instance, where the website or application relates to booking a short term rental, and the circumstances indicate that the time is late, the weather is bad, the area is unsafe, and/or other relevant factors, such factors may be applied by workflow logic 220 to determine how to direct user workflow. Of course, the foregoing is merely exemplary and other embodiments may differ.

In one embodiment, user sentiment, circumstantial evidence, and the availability of self-serve options may be factors that are variously weighted by one or more machine learning algorithms (e.g., linear regression models). Such algorithms may be trained on a training set of various scenarios with selected or procedurally generated combinations of circumstantial and workflow scenarios. In another embodiment, machine learning analyses may be applied to determine sentiment, but the determination of workflow may be subsequently applied to a rules-based process, e.g., where escalation or other alternate remediation is always applied in certain defined circumstances.

Accordingly, based on the determinations of step 650, calculated user sentiment, and/or circumstantial data, the workflow logic 220 may present to the user different workflows. Examples of these different directed activities may be seen by comparison of screen 418 of FIG. 4B, which presents 3 different self-solve methods, and screen 452 of FIG. 4D, which provides only a link 452-3 to an escalated customer support process. If the user is unhappy with the presented options or wishes to provide additional information, they may do so in field 452-4 of FIG. 4D.

FIG. 4E illustrates one exemplary interaction between the user device 150, a survey UI 460 and the system 110. Upon an initial determination that the user is done with their workflow, the process switches to a survey workflow (462), in which a series of questions (e.g., 464) may be transmitted to the user in between generation and updates of the survey instance. When the survey is complete (here, after receiving a response to the second question), the system 110 marks the survey as complete and sends an event trigger to initiate an alternate work or other remedial action.

In a conventional implementation, surveys were conducted through human-to-human interaction via guest complaint, customer support calls, and/or subsequent customer surveys. The response rate and quality of feedback achieved by these surveys is minimal, and is skewed toward negative responses. Because customer sentiment changes rapidly, these late-received feedback responses typically do not accurately reflect true customer feedback. Further, because the feedback is only considered after the fact, problems experienced by a user cannot be avoided or mitigated.

In contrast, the systems and methods described herein provide an interface to collect feedback from web, mobile, messaging (e.g., chatbot), email, SMS, and other text-based channels. Further, the system provides for intelligent automated control of when to trigger surveys or other interfaces (e.g., chatbot or text surveys) for display to users so as to be most helpful. Further still, customer workflows can be inferred and additional signals, such as customer sentiment, can be collected directly from and during a support interaction. These signals and workflows can be analyzed in real-time using NLP analysis, and tailored questions and responses can be provided to the user in real-time in a manner and language that is accessible to them, without delay and without changing medium. Further, targeted actions (such as workflow routing) can be taken in response to the user's current sentiment and workflow history. These functionalities cannot be achieved through conventional post-event survey solutions. Additionally, the amount of historical and contextual data that can be considered as part of this analysis could not be processed and analyzed on pen and paper or by the human mind at the scale and speed permissible by the machine learning solutions described herein.

In an embodiment, the possible responses provided to a customer from the thematic response data 234 can be updated and tailored to the customer. One or more machine learning models can be continually trained on a training set of customer activities and workflows, customer sentiment scores and customer preferences (e.g., survey data about a provided response) and reactions (e.g., a customer's subsequent actions to a provided response) from many customers to determine which responses, of those possibly included in the thematic response data 234, would be more likely to lead to success for an individual customer in completing an activity.

In some embodiments, particular data in the training set may be weighted to address particular events experienced by the customers. In an embodiment, training of the model and the addition of new (or modified) thematic response data 234 can be performed without human intervention. The model can self-evaluate to ensure a baseline performance and the model can self-improve through randomized experimentation. A newly trained model can also compare itself to a previous model to find the one model most likely to provide responses with various or diverse customer outcomes including customer success, customer sentiment, and distribution of customer evaluations. In one embodiment, the model can be trained by at least three inputs: the customer's direct evaluation of the provided response, the customer's indirect evaluation of the provided response through the customer's future actions and an expert's (e.g., a customer service agent's) evaluation. The use of the three inputs can aid the model in balancing the different incentives of the participants (e.g., customers and experts).

In one embodiment, the machine learning model can be used to dynamically generate or select a response for the customer to assist the customer in completing an activity while the customer is actively engaged in a workflow. In another embodiment, the machine learning model can be applied prior to the initiation of a workflow by the customer to dynamically generate thematic response data 234 for the customer such that a subsequent response selected for a customer from the thematic response data 234 better resolves the customer's problems. The machine learning model can be used to generate unique thematic response data 234 for each customer such that responses provided to one customer for a particular situation do not match the responses provided to another customer for the same situation.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A method for directing textual conversation based on user workflow, the method comprising:
obtaining, by a web server, information regarding a user workflow, the information regarding the user workflow representing a progression of one or more user interfaces with which a user has interacted within a session;
determining, based on the user workflow, an activity target for the user;
presenting, by the web server, a user interface capable of accepting freeform text input from the user;
receiving, by the web server, a character string via the user interface;
generating a vector encoding of the character string;
calculating, based on the vector encoding, a user sentiment score for the character string;
generating, based on the user sentiment score, a response to the character string using a machine learning model, wherein the response to the character string contains information routing the user to an updated path to the activity target; and
displaying, via the user interface, the generated response.

2. The method of claim 1, further comprising:
obtaining, by the web server, information regarding a continued user workflow;
determining, from the continued user workflow, whether the user completed the activity target;
modifying the user sentiment score based on whether the user completed the activity target; and
taking one or more responsive actions based on the modified user sentiment score.

3. The method of claim 1, where the user interface is a chat application permitting real-time exchange of text between a user device and a remote system, wherein the character string is provided by the user as freeform text entry into the chat application and the generated response to the character string is provided to the user in the chat application in reply to the freeform text entry into the chat application.

4. The method of claim 1, wherein the generating of the response to the character string is further based on at least one of user location data and user language data stored, in a memory, in association with information identifying the user.

5. The method of claim 1, wherein the calculating of the user sentiment score for the character string comprises: applying one or more natural language processing (NLP) models to perform a sentiment analysis of the character string.

6. The method of claim 1, wherein the updated path to the activity target comprises at least one of: a self-solve workflow, an agent-controlled workflow, and a cancellation workflow.

7. The method of claim 2, wherein the one or more responsive actions comprises: (a) displaying, via the user interface, one or more instructions regarding a self-solve action, and (b) generating a support ticket and transmitting the support ticket, via a network, to a support agent.

8. The method of claim 7, wherein the support agent is a human actor.

9. The method of claim 1, wherein the generating a vector encoding of the character string comprises: applying a machine learning model to the character string to generate the vector encoding.

10. The method of claim 1, wherein the generating a response to the character string comprises: applying a machine learning model to the user sentiment score and available self-solve actions to generate the response to the character string.

11. A system comprising:
a memory configured to store (a) one or more vector encodings of textual data and (b) information regarding a user workflow, the information regarding the user workflow representing a progression of one or more user interfaces with which a user has interacted within a session; and
at least one processor configured to:
determine, based on the user workflow, an activity target for the user;
transmit, to a user device, a user interface capable of accepting freeform text input from the user;
receive one or more character strings via the user interface;
generate a vector encoding of the one or more character strings;
calculate, based on the vector encoding, a user sentiment score for the character string;
generate, based on the user sentiment score, a response to the character string, wherein the response to the character string contains information routing the user to an updated path to the activity target; and
transmit, via the user interface, the generated response.

12. The system of claim 11, wherein the at least one processor is further configured to:
obtain information regarding a continued user workflow of the user;
determine, from the continued user workflow, whether the user completed the activity target;
modify the user sentiment score based on whether the user completed the activity target; and
take one or more responsive actions based on the modified user sentiment score.

13. The system of claim 11, where the user interface is a chat application permitting real-time exchange of text between a user device and a remote system, wherein the character string is provided by the user as freeform text entry into the chat application and the generated response to the character string is provided to the user in the chat application in reply to the freeform text entry into the chat application.

14. The system of claim 11, wherein the generating of the response to the character string is further based on at least one of: user location data and user language data stored, in a memory, in association with information identifying the user.

15. The system of claim 11, wherein the calculating of the user sentiment score for the character string comprises: applying one or more natural language processing (NLP) models to perform a sentiment analysis of the character string.

16. The system of claim 11, wherein the updated path to the activity target comprises at least one of: a self-solve workflow, an agent-controlled workflow, and a cancellation workflow.

17. The system of claim 12, wherein the one or more responsive actions comprises: (a) displaying, via the user interface, one or more instructions regarding a self-solve action, and (b) generating a support ticket and transmitting the support ticket, via a network, to a support agent.

18. The system of claim 17, wherein the support agent is a human actor.

19. The system of claim 11, wherein the at least one processor is further configured to apply a machine learning model to the character string to generate the vector encoding.

20. The system of claim 11, wherein the at least one processor is further configured to apply a machine learning model to the user sentiment score and available self-solve actions to generate the response to the character string.
